(19) United States
(12) Patent Application Publication
(10) Pub. No.: US 2018/0311590 A1
(43) Pub. Date: Nov. 1, 2018

(54) Clicking Mechanism Toys

(71) Applicant: Chad M. Rasmussen, Plain City, UT (US)

(72) Inventor: Chad M. Rasmussen, Plain City, UT (US)

(21) Appl. No.: 15/802,064

(22) Filed: Nov. 2, 2017

Related U.S. Application Data
(60) Provisional application No. 62/417,290, filed on Nov. 3, 2016.

(51) Int. Cl. A63H 3/00; H01H 3/12; F21V 33/00; F21V 23/04; F21V 8/00; A63F 9/00; A63F 9/24; A63H 5/00

(52) U.S. Cl. CPC A63H 3/006; H01H 3/12; F21V 33/008; F21V 23/04; H01H 9/0214; A63F 9/0096; A63F 9/24; A63H 5/00; G02B 6/0005

(57) ABSTRACT

A clicking mechanism toy having a body and head in the form of an animal or insect. The body accommodates a multitude of clicking mechanisms. Optionally a depressible push button of the clicking mechanism is colored, is transparent and can be illuminated. Also optionally such a version can be used in a pattern game where a push button illuminates until it is depressed and in another game where a user determines how fast the user can press an illuminated push button, causing the illumination to cease. The light can be within a housing for the push button or within the body of the toy. In one such version the single light directly illuminates all the push buttons, and in another such version fiber optic fibers go from a light source to each push button, enabling individual control and the aforementioned games.

### CROSS-REFERENCE TO RELATED APPLICATION

This application claims the benefit of U.S. Provisional Application No. 62/417,290, filed Nov. 3, 2016.

### BACKGROUND OF THE INVENTION

### Field of the Invention

The present invention relates generally to handheld toys used by children and adults. More particularly, it relates to animal or insect shaped toys with clicking mechanisms throughout used for the purposes of amusement and or to reduce stress.

### Description of the Related Art

Repeatedly clicking a retractable pen is a common occurrence by adults and children in different settings such as in the home, at school, or the work place. Some people do this as a way to pass time because of boredom while others use it as a way to reduce stress or nervousness.

Adults and especially children like a wide variety of small toys such as animal toys, cartoon characters and the like. They are often stuffed toys, plastic and various other forms. They can bring comfort to a tired or scared child by holding or snuggling the toy, or simply amusement to play with.

Accordingly, what is needed is a toy that incorporates the clicking mechanism of a retractable pen top—the part that is pressed to click the pen open for writing—to help reduce stress or nervousness, combined with a toy form for play or comfort.

The original patent for the electronic game Simon is U.S. Pat. No. 4,207,087. Simon illuminated lights on a disk-shaped device. A player had to repeat the sequence in which Simon displayed lights. The sequences became progressively more difficult.

Originally owned by Milton Bradley, Simon is now owned by Hasbro.

### BRIEF SUMMARY OF THE INVENTION

The present invention provides traditional clicking mechanisms similar to a retractable pen top in substantial numbers combined with a wide variety of toys. This provides the user amusement, entertainment, and or stress relief.

The current invention utilizes various animal species which have spiny or sharp projections, such—as but not limited to—a hedgehog, pufferfish, porcupine, lizard, or snake. It may also utilize animals or insects with the appearance of spots, hair, or fur such as but not limited to a ladybug, pig, or bear.

The animal comprises the toy and frame or structure for the clicking mechanisms. There could be many clicking mechanisms on the animal's body as, for example, on a pufferfish or hedgehog, or only a few clicking mechanisms on the animal's body as, for example, on a ladybug.

### BRIEF DESCRIPTION OF THE SEVERAL VIEWS OF THE DRAWING

FIG. 1 is an elevational side view of the present invention in hedgehog form.

FIG. 2 is an elevational front view of the embodiment in FIG. 1.

FIG. 3 illustrates one form of the clicking mechanism installed in an animal body of the present invention

FIG. 4 portrays a user's hand operating the toy of the present invention.

FIG. 5 shows an embodiment of the present invention in the form of a pufferfish and also an embodiment of the present invention in the form of a ladybug.

### DETAILED DESCRIPTION OF THE INVENTION

The body 15 of the animal 1 is formed in such a way as to accommodate the clicking mechanisms 16 through any manner that is well known in the art. The clicking mechanism 16 is any that is well known in the art and comprises a push button 3, 4 that protrudes outside the body of the animal 1 at least when extended and may have the appearance of a retractable pen top.

Accommodated inside the body 15 of the animal 1 is the clicking mechanism housing 8 from which extends a portion of the push button 3, 4. The housing 8 preferably also holds a thrust tube 6 below the push button 3, 4; thrust device 7 below the thrust tube 6; and spring 9 below the thrust device 7 and above the bottom 17 of the housing 8. This allows the user to press the button 3, 4 down so that it moves close to, but preferably not into, the body 15 of the toy 1 and then stops. It remains in this position unless the user presses it again and it releases back to the full upward position by spring action similar to a traditional retractable pen. This process can be done repeatedly by the user and, through any device or devices that are well known in the art, makes a distinct clicking noise as the button 3, 4 is pressed or depressed. Other noises or sensations known in the art could optionally be incorporated into the clicking mechanism 16. The clicking mechanism 16 could also be silent yet still sensory.

The clicking mechanism 16 can serve several functions. A first is simply to serve have a press button 3, 4 that makes a clicking noise when pressed or depressed. The user may depress many press buttons 3, 4 across the body 15 of the toy 1 leaving some extended and others depressed; depress many at the same time; or, do in this regard, whatever the user may choose. A second and optional function is to illuminate a light. The toy 1 can be fitted with a device 11 for connecting to an electrical power source, such as a battery or electrical outlet, with a wire 10 connected, in any manner that is known in the art, from the device 11 through each clicking mechanism housing 8 to a light placed, in any manner that is known in the art, within the housing 8 and, preferably within the push button 3, in any manner that is well known in the art so that, when, and only when, the button 3, 4 is depressed, the light within the housing 8 will illuminate. The button 3, 4 is transparent so that the illumination passes through it. Either the light can be colored with the push button 3, 4 being clear, i.e., having no color, or the light can be white with the push button being transparent but colored.

For example, there could be clear plastic push buttons 3, 4 with varying colors, such as—but not limited to—red, blue, yellow, purple, or green, or all one color, such as red, throughout. This could add enjoyment for the user in various low light conditions.

Another option to illuminate the buttons 3, 4 is to have one light bulb within the interior of the body 15 of the toy 1 that gives off light to shine through the clear push buttons 3, 4.

Still another option is the use of fiber optics fibers going to each push button 3, 4 from a central light source within the body 15 of the toy 1 giving off the light to be transmitted selectively to the buttons 3, 4 as determined by any light control mechanism that is well known within the art and is illuminated by the light.

A game component can also optionally be included with the pressing of the buttons 3, 4, such as—but not limited to—a pattern game or game of quickness when the lights are selectively illuminated, which can occur when the light is in each housing 8 or when fiber optics fibers are employed but not when there is just a central light source within the body 15. The user turns on the game mode, through any game activation and deactivation device that is well known in the art, and, through any game selection device that is well known within the art, selects the mode of play.

In the pattern game mode the push button 3 illuminates as directed by any light control mechanism that is well known within the art; the user then presses the illuminated push button 3; and thereupon, at the direction of any light control mechanism that is well known within the art, the push button ceases to be illuminated. This is then followed by another push button illuminating and so on.

In the quickness mode time is not tracked but, when the light control mechanism causes a push button 3 to be illuminated, the user simply presses the push button 3 as fast as the user is able. The light control mechanism then stops the push button 4 from being illuminated. Thereafter another push button 3 illuminates.

The size of the toy 1 can vary from a small handheld toy to a larger toy 1.

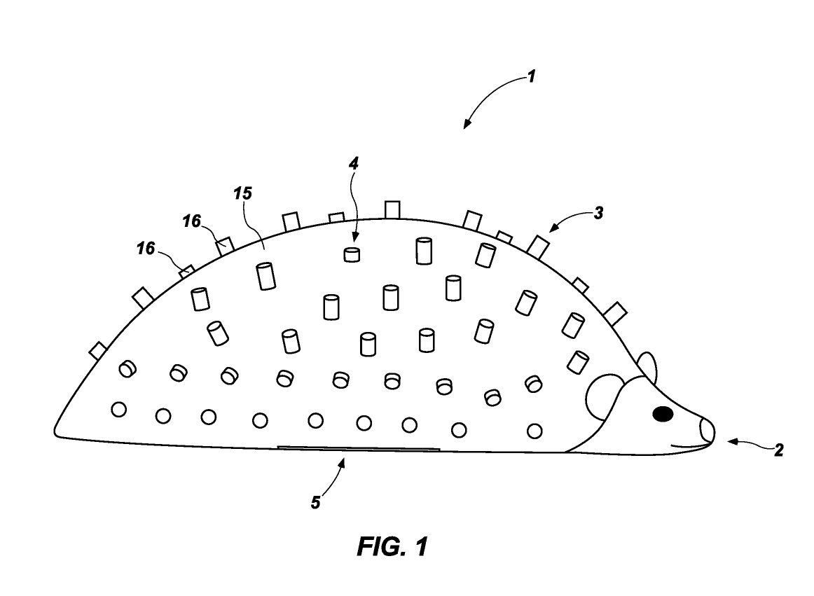

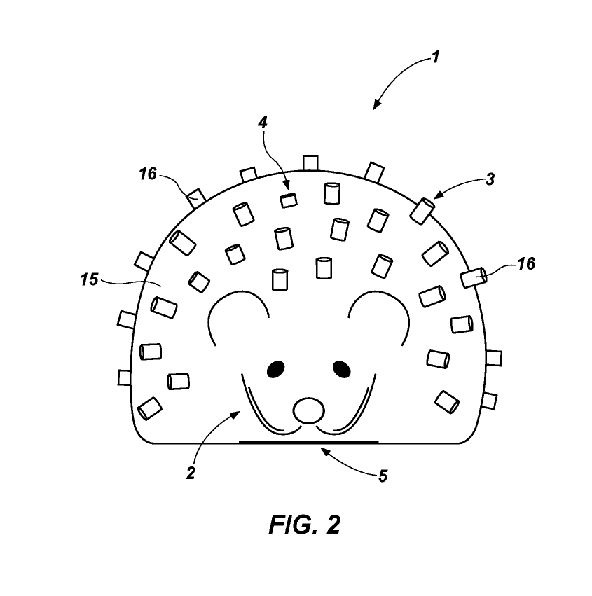

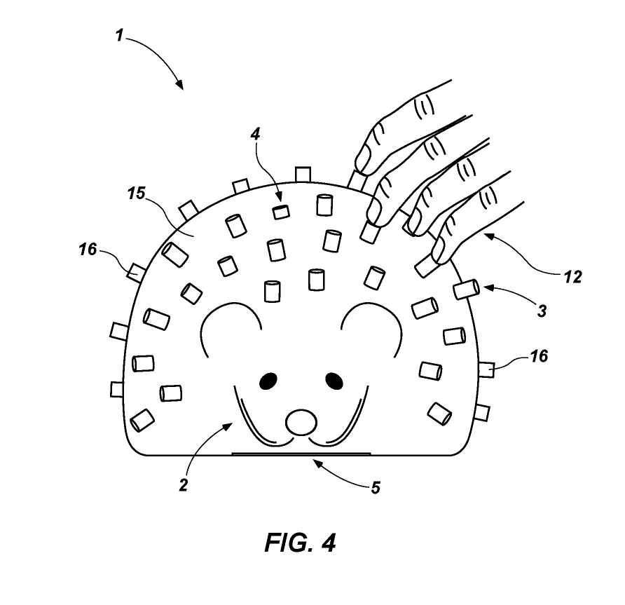

Referring to the invention in more detail, FIG. 1, FIG. 2 and FIG. 4 illustrate an embodiment of the clicking mechanism toy 1 in the form of a hedgehog; but as suggested above the toy can be made in the shape many different animal or insect species.

There is shown in FIG. 1, FIG. 2, and FIG. 4 the face or head 2 of the animal toy 1; the frame or body 15 of the animal toy 1; the clicking mechanism or press button, some in the fully extended position 3 and others in the depressed position 4; and an aperture 5 which can be closed with any structure known in the art, where the device for connecting to an electrical power source 11, and wiring are located.

The toy 1 can be made in various sizes, as mentioned above, and from various colors and materials known in the art.

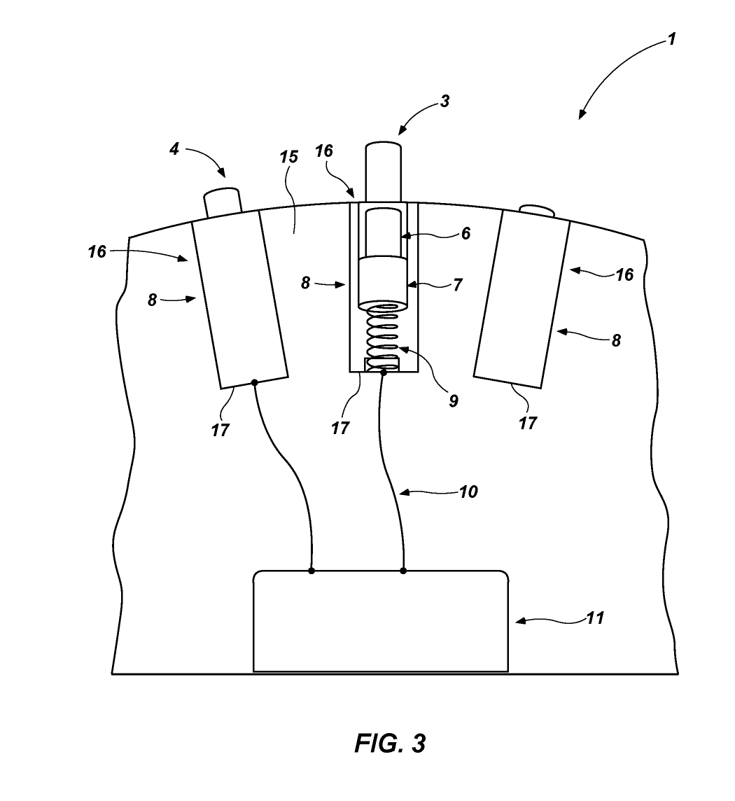

As indicated above, FIG. 3 shows an interior view of the toy 1 and one embodiment of the clicking mechanism 3, such illustrative embodiment having a thrust tube 6, a thrust device 7, a spring 9, and a housing 8 for the clicking mechanism. In this one illustrative embodiment the user presses the clicking mechanism or press button 3, 4 downward placing pressure on the thrust tube 6, the thrust device 7, and the spring 9 thereby causing the clicking mechanism to make a distinct clicking sound while lowering and remaining in the seated or depressed position 4.

FIG. 4 shows the toy 1 with a person's fingers 12 pressing the clicking mechanisms or press buttons 3, 4.

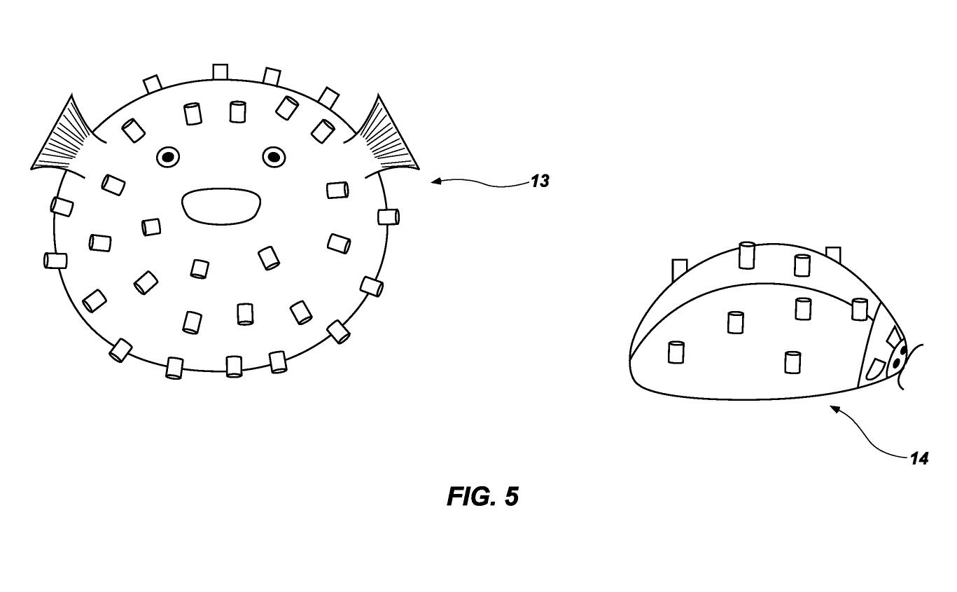

FIG. 5 shows other potential toy forms such as but not limited to a pufferfish 13 and a ladybug 14.

While the included written background, summary, description and drawings of the invention enables one of ordinary skill to make and use what is considered presently to be the best mode thereof, those of ordinary skill will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A clicking mechanism toy, which comprises:
a body and head in the form of an animal or insect; and
accommodated within said body a multitude of clicking mechanisms.

2. A clicking mechanism toy, which comprises:
a body and head in the form of an animal or insect;
accommodated within said body a multitude of clicking mechanisms, each of said clicking mechanisms comprising:
a housing;
a depressible push button that, in its extended state, extends from the housing and outward from the body of the animal and, when depressed, makes a clicking noise;
a thrust tube below the push button;
a thrust device below the thrust tube; and
a spring below the thrust device and above the bottom of said housing.

3. The clicking mechanism toy as recited in claim 2, wherein:
the push buttons are transparent; and further comprising:
a light within said housing that is activated when its associated push button is depressed and deactivated when its associated push button is extended;
a device for connecting to an electrical power source;
a wire connecting the electrical power source connecting device to the light

4. The clicking mechanism toy as recited in claim 2, wherein:
the push buttons are transparent; and further comprising:
a light within said housing;
a game activation and deactivation device; and
a light control mechanism for selectively illuminating lights and for causing the light to cease to be illuminated when its associated push button is pressed.

5. The clicking mechanism toy as recited in claim 2, further comprising:
the push buttons are transparent; and further comprising:
a light within said housing;
a game activation and deactivation device; and
a light control mechanism for selectively illuminating a light and for causing the light to cease to be illuminated when its associated push button is pressed.

6. The clicking mechanism toy as recited in claim 2, wherein:
the push buttons are transparent; and further comprising:
a light within said body;
a device for connecting to an electrical power source; and
a wire connecting the electrical power source connecting device to the light.

7. The clicking mechanism toy as recited in claim 6, wherein:
a light control mechanism illuminated by said light; and
fiber optic fibers, with one of such fiber optic fibers running from said light control mechanism to each push button.

8. The clicking mechanism toy as recited in claim 7, further comprising:
a game activation and deactivation device; and wherein:
said light control mechanism selectively illuminates lights causes the light to cease to be illuminated when its associated push button is pressed.

9. The clicking mechanism toy as recited in claim 7, further comprising:
a game activation and deactivation device; and wherein:
the light control mechanism selectively illuminates a light and causes the light to cease to be illuminated when its associated push button is pressed.
